(19) United States
(12) Patent Application Publication
(10) Pub. No.: US 2024/0406787 A1
(43) Pub. Date: Dec. 5, 2024

(54) METHOD AND APPARATUS FOR PACKET DUPLICAITON

(71) Applicant: Lenovo (Beijing) Limited, Beijing (CN)

(72) Inventors: Jing Han, Beijing (CN); Ran Yue, Beijing (CN); Lianhai Wu, Beijing (CN); Haiming Wang, Beijing (CN); Jie Hu, Beijing (CN)

(73) Assignee: Lenovo (Beijing) Limited, Beijing (CN)

(21) Appl. No.: 18/699,543

(22) PCT Filed: Oct. 9, 2021
(86) PCT No.: PCT/CN2021/122857

§ 371 Date: Apr. 8, 2024

(51) Int. Cl. H04W 28/02; H04W 92/18

(52) U.S. Cl. CPC H04W 28/0263; H04W 28/0268; H04W 92/18

(57) ABSTRACT

Embodiments of the present application relate to a method and apparatus for packet duplication. According to an embodiment of the present application, a method may include: determining whether to enable or disable a packet duplication associated with one or more quality of service (QOS) flows mapped into sidelink radio bearers (SLRBs) based on a duplication determination rule; and in response to determining to enable a packet duplication, performing the packet duplication.

### TECHNICAL FIELD

Embodiments of the present application generally relate to wireless communication technology, especially to a method and apparatus for packet duplication in sidelink (SL).

### BACKGROUND

In Rel-15, multi-carrier operation was introduced for long term evolution (LTE) vehicle to everything (V2X) system. In the V2X system, multiple carriers can be supported on sidelink and a user equipment (UE) can select one or multiple carriers for data transmission. At that time, packet duplication can be configured for UE, and UE will perform the packet duplication in a packet data convergence protocol (PDCP) layer for services with high reliability requirement.

As the sidelink development in Rel-18, multi-carrier operation may also be introduced for new radio (NR) sidelink to fulfill SL services that need high throughput and high reliability. Packet duplication is one of the key schemes for multi-carrier operation in NR SL.

However, the quality of service (QOS) model for NR SL is different from that for LTE V2X, and thus the packet duplication rule used for LTE V2X is not suitable for NR SL.

Given that, it is desirable to provide improved solutions for packet duplication in SL.

### SUMMARY OF THE APPLICATION

Embodiments of the present application at least provide a technical solution for packet duplication in SL, e.g., in NR SL.

According to some embodiments of the present application, an SL apparatus may include: a processor; and a transceiver coupled to the processor, wherein the processor is configured to: determine whether to enable or disable a packet duplication associated with one or more QoS flows mapped into one or more sidelink radio bearers (SLRBs) based on a duplication determination rule; and in response to determining to enable a packet duplication, perform the packet duplication.

In some embodiments of the present application, whether to perform a packet duplication based on a duplication determination rule is determined in a packet data convergence protocol (PDCP) layer of a UE.

In some embodiments of the present application, the duplication determination rule indicates: determining whether to enable or disable a packet duplication for a SLRB based on whether a QoS parameter for the SLRB is higher than or equal to a QoS parameter threshold provided by an upper layer, and wherein the processor is further configured to: receive one or more QoS parameters for the one or more QoS flows mapped into one SLRB, each QoS parameter associated with a QoS flow; determine a QoS parameter for the one SLRB with a most stringent QoS requirement of the one or more QoS flows; and determine whether to enable or disable the packet duplication for the one SLRB based on the duplication determination rule.

In some embodiments of the present application, the duplication determination rule indicates: determining whether to enable or disable the packet duplication for a SLRB based on whether a PQI associated with the SLRB is included in a PQI set provided by an upper layer, and wherein the processor is further configured to: receive one or more PQIs for the one or more QoS flows mapped into one SLRB; and determine whether to enable or disable the packet duplication for the one SLRB based on the duplication determination rule.

In some embodiments of the present application, the duplication determination rule indicates: determining whether to enable or disable the packet duplication for a SLRB based on whether a destination identity (ID) associated with the SLRB is included in a destination ID set provided by an upper layer, and wherein the processor is further configured to: receive a destination ID for the one or more QoS flows mapped into one SLRB; and determine whether to enable or disable the packet duplication for the one SLRB based on the duplication determination rule.

In some embodiments of the present application, the duplication determination rule indicates: determining whether to enable or disable the packet duplication for a SLRB on a carrier at least based on whether a SL grant failure number on the carrier during a time period reaches a SL grant failure number threshold provided by an upper layer, and wherein the processor is further configured to: receive, from a medium access control (MAC) layer of the UE, an indication indicating that the SL grant failure number on the carrier during the time period reaches the SL grant failure number threshold; and determine whether to enable or disable the packet duplication for at least one SLRB on the carrier of the one or more SLRBs at least based on the indication.

In some embodiments of the present application, whether to perform a packet duplication based on a duplication determination rule is determined in a service data adaptation protocol (SDAP) layer of a UE.

In some embodiments of the present application, the duplication determination rule indicates: determining whether to enable or disable a packet duplication for a QoS flow based on whether a QoS parameter associated with the QoS flow is higher than or equal to a QoS parameter threshold provided by an upper layer, and wherein the processor is further configured to: determine whether to enable or disable the packet duplication for a QoS flow of the one or more QoS flows based on the duplication determination rule; in response to determining to enable the packet duplication: map the QoS flow into a first SLRB for which the packet duplication is enabled of the one or more SLRBs; and in response to determining to disable the packet duplication: map the QoS flow into a second SLRB for which the packet duplication is disabled.

In some embodiments of the present application, the duplication determination rule indicates: determining whether to enable or disable the packet duplication for a QoS flow based on whether a PQI of the QoS flow is included in a PQI set provided by an upper layer, and wherein the processor is further configured to: determine whether to enable or disable the packet duplication for a QoS flow of the one or more QoS flows based on the duplication determination rule; in response to determining to enable the packet duplication: map the QoS flow into a first SLRB for which the packet duplication is enabled of the one or more SLRBs; in response to determining to disable the packet duplication: map the QoS flow into a second SLRB for which the packet duplication is disabled of the one or more SLRBs.

In some embodiments of the present application, the duplication determination rule indicates: determining whether to enable or disable the packet duplication for a QoS flow based on whether a destination ID of the QoS flow is included in a destination ID set provided by an upper layer, and wherein the processor is further configured to: determine whether to enable or disable the packet duplication for a QoS flow of the one or more QoS flows based on the duplication determination rule; in response to determining to enable the packet duplication: map the QoS flow into a first SLRB for which the packet duplication is enabled of the one or more SLRBs; and in response to determining to disable the packet duplication: map the QoS flow into a second SLRB for which the packet duplication is disabled of the one or more SLRBs.

In some embodiments of the present application, the first SLRB for which the packet duplication is enabled or the second SLRB for which the packet duplication is disabled is configured by a radio resource control (RRC) layer.

In some embodiments of the present application, the processor is further configured to: in response to determining to enable the packet duplication: indicate, to a PDCP layer of the UE, that the packet duplication is enabled for the first SLRB; and in response to determining to disable the packet duplication: indicate, to the PDCP layer of the UE, that the packet duplication is disabled for the second SLRB.

In some embodiments of the present application, the duplication determination rule indicates: determining whether to enable or disable the packet duplication for a QoS flow on a carrier at least based on whether a SL grant failure number on the carrier during a time period reaches a SL grant failure number threshold provided by an upper layer, and wherein the processor is further configured to: receive, from a medium access control (MAC) layer of the UE, an indication indicating that the SL grant failure number on the carrier during the time period reaches the SL grant failure number threshold; and determine whether to enable or disable the packet duplication for at least one QoS flow on the carrier of the one or more QoS flows at least based on the indication.

In some embodiments of the present application, the duplication determination rule indicates: determining whether to enable or disable the packet duplication for a packet from a QoS flow based on whether a QoS parameter associated with the QoS flow is higher than or equal to a QoS parameter threshold provided by an upper layer, and wherein the processor is further configured to: determine whether to enable or disable the packet duplication for a packet from a QoS flow of the one or more QoS flows based on the duplication determination rule; in response to determining to enable the packet duplication for the packet; indicate, to a PDCP layer of the UE, that the packet duplication is enabled for the packet; and in response to determining to disable the packet duplication for the packet, indicate, to the PDCP layer of the UE, that the packet duplication is disabled for the packet.

In some embodiments of the present application, the duplication determination rule indicates: determining whether to enable or disable the packet duplication for a packet from a QoS flow based on whether a PQI of the QoS flow is included in a PQI set provided by an upper layer, and wherein the processor is further configured to: determine whether to enable or disable the packet duplication for a packet from a QoS flow of the one or more QoS flows based on the duplication determination rule; in response to determining to enable the packet duplication for the packet; indicate, to a PDCP layer of the UE, that the duplication packet is enabled for the packet; and in response to determining to disable the packet duplication for the packet, indicate, to the PDCP layer of the UE, that the packet duplication is disabled for the packet.

In some embodiments of the present application, the duplication determination rule indicates: determining whether to enable or disable a packet duplication for a packet from a QoS flow based on whether a destination ID of the QoS flow is included in a destination ID set provided by an upper layer, and wherein processor is further configured to: determine whether to enable or disable a packet duplication for a packet from a Qos flow of the one or more QoS flows based on the duplication determination rule; in response to determining to enable the packet duplication for the packet; indicate, to a PDCP layer of the UE, that the packet duplication is enabled for the packet; and in response to determining to disable the packet duplication for the packet, indicate, to the PDCP layer of the UE, that the packet duplication is disabled for the packet.

In some embodiments of the present application, the duplication determination rule indicates: determining whether to enable or disable the packet duplication for a packet on a carrier at least based on whether a SL grant failure number on the carrier during a time period reaches a SL grant failure number threshold provided by an upper layer, and wherein the processor is further configured to: receive, from a MAC layer of the UE, an indication indicating the SL grant failure number on the carrier during the time period reaches the SL grant failure number threshold; and determine whether to enable or disable a packet duplication for a packet on the carrier from a Qos flow of the one or more QoS flows at least based on the indication.

In some embodiments of the present application, performing the packet duplication includes activating additional one or more legs configured by the network.

According to some embodiments of the present application, a method may include: determining whether to enable or disable a packet duplication associated with one or more QoS flows mapped into SLRBs based on a duplication determination rule; and in response to determining to enable a packet duplication, performing the packet duplication.

In some embodiments of the present application, whether to perform a packet duplication based on a duplication determination rule is determined in a PDCP layer of a UE.

In some embodiments of the present application, the duplication determination rule indicates: determining whether to enable or disable a packet duplication for a SLRB based on whether a QoS parameter for the SLRB is higher than or equal to a QoS parameter threshold provided by an upper layer, and wherein the method further includes: receiving one or more QoS parameters for the one or more QoS flows mapped into one SLRB, each QoS parameter associated with a QoS flow; determining a QoS parameter for the one SLRB with a most stringent QoS requirement of the one or more QoS flows; and determining whether to enable or disable the packet duplication for the one SLRB based on the duplication determination rule.

In some embodiments of the present application, the duplication determination rule indicates: determining whether to enable or disable the packet duplication for a SLRB based on whether a PQI associated with the SLRB is included in a PQI set provided by an upper layer, and wherein the method further includes: receiving one or more PQIs for the one or more QoS flows mapped into one SLRB; and determining whether to enable or disable the packet duplication for the one SLRB based on the duplication determination rule.

In some embodiments of the present application, the duplication determination rule indicates: and wherein the method further includes: receiving a destination ID for the one or more QoS flows mapped into one SLRB; and determining whether to enable or disable the packet duplication for the one SLRB based on the duplication determination rule.

In some embodiments of the present application, the duplication determination rule indicates: determining whether to enable or disable the packet duplication for a SLRB on a carrier at least based on whether a SL grant failure number on the carrier during a time period reaches a SL grant failure number threshold provided by an upper layer, and wherein the method further includes: receiving, from a MAC layer of the UE, an indication indicating that the SL grant failure number on the carrier reaches the SL grant failure number threshold; and determining whether to enable or disable the packet duplication for at least one SLRB on the carrier of the one or more SLRBs at least based on the indication.

In some embodiments of the present application, whether to perform a packet duplication based on a duplication determination rule is determined in a SDAP layer of a UE.

In some embodiments of the present application, the duplication determination rule indicates: determining whether to enable or disable a packet duplication for a QoS flow based on whether a QoS parameter associated with the QoS flow is higher than or equal to a QoS parameter threshold provided by an upper layer, and wherein the method further includes: determining whether to enable or disable the packet duplication for a QoS flow of the one or more QoS based on the duplication determination rule; in response to determining to enable the packet duplication: mapping the QoS flow into a first SLRB for which the packet duplication is enabled of the one or more SLRBs; and in response to determining to disable the packet duplication: mapping the QoS flow into a second SLRB for which the packet duplication is disabled.

In some embodiments of the present application, the duplication determination rule indicates: determining whether to enable or disable the packet duplication for a QoS flow based on whether a PQI of the QoS flow is included in a PQI set provided by an upper layer, and wherein the method further includes: determining whether to enable or disable the packet duplication for a QoS flow of the one or more QoS flows based on the duplication determination rule; in response to determining to enable the packet duplication: mapping the QoS flow into a first SLRB for which the packet duplication is enabled of the one or more SLRBs; in response to determining to disable the packet duplication: mapping the QoS flow into a second SLRB for which the packet duplication is disabled of the one or more SLRBs.

In some embodiments of the present application, the duplication determination rule indicates: determining whether to enable or disable the packet duplication for a QoS flow based on whether a destination ID of the QoS flow is included in a destination ID set provided by an upper layer, and wherein the method further includes: determining whether to enable or disable the packet duplication for a Qos flow of the one or more QoS flows based on the duplication determination rule; in response to determining to enable the packet duplication: mapping the QoS flow into a first SLRB for which the packet duplication is enabled of the one or more SLRBs; and in response to determining to disable the packet duplication: mapping the QoS flow into a second SLRB for which the packet duplication is disabled of the one or more SLRBs.

In some embodiments of the present application, the first SLRB for which the packet duplication is enabled or the second SLRB for which the packet duplication is disabled is configured by a RRC layer.

In some embodiments of the present application, the method may further include: in response to determining to enable the packet duplication: indicating, to a PDCP layer of the UE, that the packet duplication is enabled for the first SLRB; and in response to determining to disable the packet duplication: indicating, to the PDCP layer of the UE, that the packet duplication is disabled for the second SLRB.

In some embodiments of the present application, the duplication determination rule indicates: determining whether to enable or disable the packet duplication for a QoS flow on a carrier at least based on whether a SL grant failure number on the carrier during a time period reaches a SL grant failure number threshold provided by an upper layer, and wherein the method further includes: receiving, from a MAC layer of the UE, an indication indicating that the SL grant failure number on the carrier reaches the SL grant failure number threshold; and determining whether to enable or disable the packet duplication for at least one Qos flow on the carrier of the one or more QoS flows at least based on the indication.

In some embodiments of the present application, the duplication determination rule indicates: determining whether to enable or disable the packet duplication for a packet from a QoS flow based on whether a QoS parameter associated with the QoS flow is higher than or equal to a QoS parameter threshold provided by an upper layer, and wherein the method further includes: determining whether to enable or disable the packet duplication for a packet from a QoS flow of the one or more QoS flows based on the duplication determination rule; in response to determining to enable the packet duplication for the packet; indicating, to a PDCP layer of the UE, that the packet duplication is enabled for the packet; and in response to determining to disable the packet duplication for the packet, indicating, to the PDCP layer of the UE, that the packet duplication is disabled for the packet.

In some embodiments of the present application, the duplication determination rule indicates: determining whether to enable or disable the packet duplication for a packet from a QoS flow based on whether a PQI of the QoS flow is included in a PQI set provided by an upper layer, and wherein the method further includes: determining whether to enable or disable the packet duplication for a packet from a QoS flow of the one or more QoS flows based on the duplication determination rule; in response to determining to enable the packet duplication for the packet; indicating, to a PDCP layer of the UE, that the duplication packet is enabled for the packet; and in response to determining to disable the packet duplication for the packet, indicating, to the PDCP layer of the UE, that the packet duplication is disabled for the packet.

In some embodiments of the present application, the duplication determination rule indicates: determining whether to enable or disable a packet duplication for a packet from a QoS flow based on whether a destination ID of the QoS flow is included in a destination ID set provided by an upper layer, and wherein the method further includes: determining whether to enable or disable a packet duplication for a packet from a Qos flow of the one or more QoS flows based on the duplication determination rule; in response to determining to enable the packet duplication for the packet; indicating, to a PDCP layer of the UE, that the packet duplication is enabled for the packet; and in response to determining to disable perform the packet duplication for the packet, indicating, to the PDCP layer of the UE, that the packet duplication is disabled for the packet.

In some embodiments of the present application, the duplication determination rule indicates: determining whether to enable or disable the packet duplication for a packet on a carrier at least based on whether a SL grant failure number on the carrier during a time period reaches a SL grant failure number threshold provided by an upper layer, and wherein the method further includes: receiving, from a MAC layer of the UE, an indication indicating the SL grant failure number on the carrier reaches the SL grant failure number threshold; and determining whether to enable or disable a packet duplication for a packet from a Qos flow of the one or more QoS flows on the carrier at least based on the indication.

In some embodiments of the present application, performing the packet duplication includes activating additional one or more legs configured by the network.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary per-flow PC5 QoS model according to some embodiments of the present application;

FIG. 3 is a flow chart illustrating an exemplary method for packet duplication according to some embodiments of the present application; and

FIG. 4 illustrates a simplified block diagram of an exemplary apparatus for packet duplication according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., NR), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

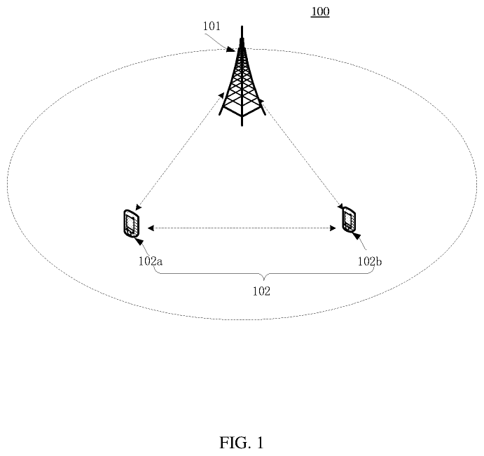

FIG. 1 is a schematic diagram illustrating an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE(s) 102 may include vehicle UEs (VUEs) and/or power-saving UEs (also referred to as power sensitive UEs). The power-saving UEs may include vulnerable road user (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE.

According to some other embodiments of the present application, the UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 102 may include wearable devices, such as smart watches, fitness bands, optical head-mounted displays, or the like.

Moreover, the UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 may transmit information to the BS 101 and receive control information from the BS 101, for example, via LTE or new radio (NR) Uu interface.

According to some embodiments of FIG. 1, the UE 102a may function as a transmitting (Tx) UE, and the UE 102b may function as a receiving (Rx) UE. The UE 102a may transmit messages to the UE 102b through a sidelink, for example, PC5 interface as defined in 3GPP standard documents. The UE 102a may transmit information or data to other UE(s) within the wireless communication system 100, through sidelink unicast, sidelink groupcast, or sidelink broadcast. For instance, the UE 102a may transmit data to the UE 102b in a sidelink unicast session. The UE 102a may transmit data to the UE 102b and other UE(s) in a groupcast group (not shown in FIG. 1) by a sidelink groupcast transmission session. Also, the UE 102a may transmit data to the UE 102b and other UE(s) (not shown in FIG. 1) by a sidelink broadcast transmission session.

According to some other embodiments of FIG. 1, the UE 102b may function as a transmission (Tx) UE and transmit messages, and the UE 102a may function as a reception (Rx) UE and receive the messages from the UE 102b.

In Rel-15, multi-carrier operation was introduced for LTE V2X system. In the V2X system, multiple carriers can be supported on sidelink and UE can select one or multiple carriers for data transmission. At that time, packet duplication can be configured for UE, and UE will perform the packet duplication in the PDCP layer for services with high reliability requirement.

In Rel-16, sidelink is firstly introduced for NR system, but only one carrier is supported for simplicity purpose.

In Rel-17, to adapt NR sidelink for power sensitive UEs, e.g. P-UEs, public safety UEs, or commercial sidelink UEs, some power saving mechanisms were studied and introduced on NR sidelink, for example, partial sensing mechanism and sidelink discontinuous reception (DRX) mechanism.

As the sidelink development in Rel-18, multi-carrier operation may also be introduced for NR sidelink to fulfill SL services that need high throughput and high reliability. Packet duplication is one of the key schemes for multi-carrier operation.

However, the QoS model for NR SL is different from that used for LTE V2X. In LTE V2X, the QoS model may include ProSe per-packet priority (PPPP) and ProSe per-packet reliability (PPPR), and the packet duplication for LTE V2X is based on PPPR. The QoS model used for NR SL may be a per-flow PC5 QoS model, wherein a QoS flow is associated with a PQI and a PC5 QoS flow identifier (PFI), a destination ID may be associated with one or more QoS flows, and one or more QoS flows may be mapped into a SLRB.

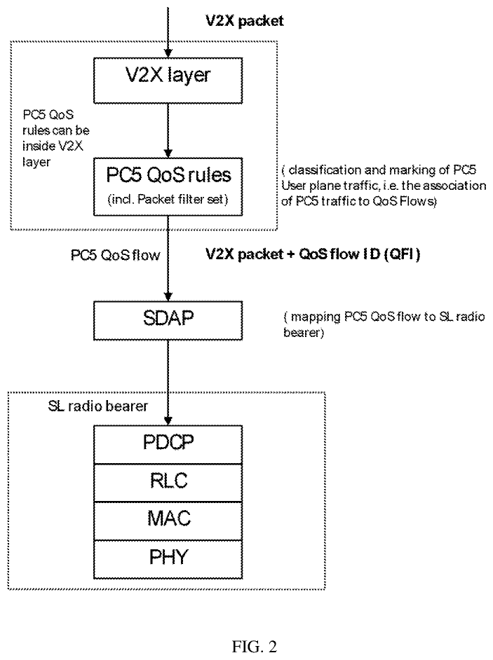

FIG. 2 illustrates an exemplary per-flow PC5 QoS model according to some embodiments of the present application. The per-flow PC5 QoS model shown in FIG. 2 refers to FIG. 5.4.1.1.1-1 in 3GPP standard document TS 23.287.

Referring to FIG. 2, the per-flow PC5 QoS model may include a V2X layer, a SDAP layer, a PDCP layer, a radio link control (RLC) layer, a medium access control layer (MAC) layer, and a physical (PHY) layer. The V2X layer may include a functional entity called PC5 QoS rules, which implement functions of classification and marking of PC5 user plane traffic, for example, the association of PC5 traffic to QoS flows. Accordingly, when receiving a V2X packet, the PC5 QoS rules inside the V2X layer may map the V2X packet to a QoS flow. Then, the SDAP layer may map the QoS flow to a SLRB. Therefore, the packet may be transmitted via the PDCP layer, RLC layer, MAC layer, and PHY layer of the SLRB.

Given the above, the QoS model for NR SL is different from that used in LTE V2X. Therefore, the packet duplication rule used for LTE V2X may be not suitable for NR SL. In addition, NR SL has different cast types (e.g., unicast, groupcast, and broadcast) and different features, and thus may have different schemes for duplication activation/deactivation.

Given this, embodiments of the present application provide a technical solution for packet duplication, which propose several packet duplication mechanisms for SL (e.g., NR SL). More details on embodiments of the present application will be illustrated in the following text in combination with the appended drawings.

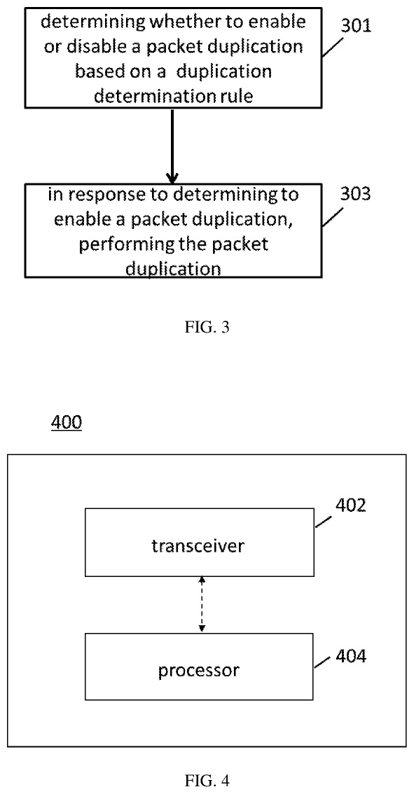

FIG. 3 is a flow chart illustrating a method for packet duplication according to some embodiments of the present application. The method illustrated in FIG. 3 may be performed by a SL apparatus, for example, a UE (e.g., the UE 102a or the UE 102b as shown in FIG. 1), a PDCP entity (or layer) of the UE, or a SDAP entity (or layer) of the UE. Persons skilled in the art can understand that the method described with respect to the UE can be implemented by other apparatus with the like functions.

In the exemplary method shown in FIG. 3, in step 301, the UE may determine whether to enable or disable a packet duplication based on a duplication determination rule. The packet duplication may be associated with one or more QoS flows which are mapped into one SLRB or mapped into multiple SLRBs.

Then, in response to determining to enable the packet duplication, in step 303, the UE may perform the packet duplication.

According to some embodiments of the present application, the PDCP layer of the UE may determine whether to perform a packet duplication based on a duplication determination rule. In such embodiments, the PDCP layer may determine whether to perform the packet duplication for a SLRB.

In an embodiment of the present application, the duplication determination rule may be based on a QoS parameter and a QoS parameter threshold (which is also referred to as a QoS parameter criterion). For example, the duplication determination rule may indicate: determining whether to enable or disable a packet duplication for a SLRB based on whether a QoS parameter for the SLRB is higher than or equal to a QoS parameter threshold provided by an upper layer. In such an embodiment, the upper layer may be a layer higher than the PDCP layer (e.g., a SDAP layer, a RRC layer, or a V2X layer). The QoS parameter may be one of QoS parameters indicated by the PQI. The QoS parameters indicated by the PQI may include: priority, packet delay budget (PDB), packet error rate (PER), etc.

In some embodiments of the present application, the QoS parameter threshold may be pre-configured in the UE, for example, in a subscriber identity module (SIM), in a universal subscriber identity module (USIM), or in a memory of the UE. In some other embodiments of the present application, the UE may receive the QoS parameter threshold in a system information block (SIB) broadcast by the BS (e.g., BS 101 as shown in FIG. 1). In some other embodiments of the present application, the UE may receive the QoS parameter threshold in a RRC signaling transmitted by the BS. No matter how the QoS parameter is obtained by the UE, for the PDCP layer of the UE, the QoS parameter threshold is provided by the upper layer.

In such embodiments, the PDCP layer may receive one or more QoS parameters for the one or more QoS flows from the upper layer. The one or more QoS flows may be mapped to one SLRB. Each QoS parameter may be associated with a QoS flow of the one or more QoS flows. Then, the PDCP layer may determine a QoS parameter for the one SLRB with the most stringent QoS requirement of the one or more QoS flows. After that, the PDCP layer may determine whether to enable or disable the packet duplication for the one SLRB based on the duplication determination rule. For example, the PDCP layer may compare the most stringent QoS requirement with the QoS parameter threshold. In the case that the most stringent QoS requirement is higher than or equal to the QoS parameter threshold, the PDCP layer may determine to enable the packet duplication for the one SLRB. Otherwise, i.e., the most stringent QoS requirement is lower than the QoS parameter threshold, the PDCP layer may determine to disable the packet duplication for the one SLRB.

For example, it is assumed that:
The QoS parameter used in the packet duplication rule may be a PER. The PDCP layer may receive a PER threshold from the upper layer;
The PDCP layer receives two PERs (e.g., PER #1 and PER #2) of two QoS flows (QOS flow #1 and QoS flow #2) mapped to one SLRB from the upper layer, wherein PER #1 is associated with QoS flow #1 and is 102. PER #2 is associated with QoS flow #2 and is 10⁻⁴.

After receiving the above information, the PDCP layer may determine the QoS parameter for the SLRB to be the most stringent QoS requirement of the two QoS flows, for example, 10⁻⁴ in this embodiment. Then, the PDCP layer may compare the 10⁻⁴ with the PER threshold. When the QoS parameter is PER and the QoS parameter threshold is PER threshold, “A QoS parameter being higher than the QoS parameter threshold” means that the PER value of a QoS flow is smaller than the PER threshold (i.e., the PER of a QoS flow is more stringent than the PER threshold). For example, in the case that the determined QoS parameter for the SLRB, 104 is smaller than or equal to the PER threshold (i.e., the QoS parameter for the SLRB is higher than the QoS parameter threshold in this case), the PDCP layer may perform the packet duplication for the one SLRB.

In another embodiment of the present application, the duplication determination rule may be based on a PQI and a PQI set (which is also referred to as a PQI criterion). For example, the duplication determination rule may indicate: determining whether to enable or disable the packet duplication for a SLRB based on whether a PQI associated with the SLRB is included in a PQI set provided by an upper layer. In such an embodiment, the upper layer may be a layer higher than the PDCP layer (e.g., a SDAP layer, a RRC layer, or a V2X layer).

In some embodiments of the present application, the PQI set may be pre-configured in the UE, for example, in a SIM, in a USIM, or in a memory of the UE. In some other embodiments of the present application, the UE may receive the PQI set in a SIB broadcast by the BS. In some other embodiments of the present application, the UE may receive the PQI set in a RRC signaling transmitted by the BS. No matter how the PQI set is obtained by the UE, for the PDCP layer of the UE, the PQI set is provided by the upper layer.

In such embodiments, the PDCP layer may receive one or more PQIs for the one or more QoS flows from the upper layer. The one or more QoS flows may be mapped to one SLRB. Each PQI may be associated with a QoS flow of the one or more QoS flows. Then, the PDCP layer may determine whether to enable or disable the packet duplication for the one SLRB based on the duplication determination rule. For example, the PDCP layer may determine whether a PQI of the one or more PQIs is included in the PQI set. In the case that the PQI is included in the PQI set, the PDCP layer may determine to enable the packet duplication for the one SLRB. Otherwise, the PDCP layer may determine to disable the packet duplication for the one SLRB.

In yet another embodiment of the present application, the duplication determination rule may be based on a destination ID and a destination ID set (which is also referred to as a destination ID criterion). For example, the duplication determination rule may indicate: determining whether to enable or disable the packet duplication for a SLRB based on whether a destination ID associated with the SLRB is included in a destination ID set provided by an upper layer. In such an embodiment, the upper layer may be a layer higher than the PDCP layer (e.g., a SDAP layer, a RRC layer, or a V2X layer).

In some embodiments of the present application, the destination ID set may be pre-configured in the UE, for example, in a SIM, in a USIM, or in a memory of the UE. In some other embodiments of the present application, the UE may receive the destination ID set in a SIB broadcast by the BS. In some other embodiments of the present application, the UE may receive the destination ID set in a RRC signaling transmitted by the BS. No matter how the destination ID set is obtained by the UE, for the PDCP layer of the UE, the destination ID set is provided by the upper layer.

In such embodiments, the PDCP layer may receive a destination ID for the one or more QoS flows from the upper layer. The one or more QoS flows may be mapped to one SLRB. Then, the PDCP layer may determine whether to enable or disable the packet duplication for the one SLRB based on the duplication determination rule. For example, the PDCP layer may determine whether the destination ID associated with the one SLRB is included in the destination ID set. In the case that the destination ID is included in the destination ID set, the PDCP layer may determine to enable the packet duplication for the one SLRB. Otherwise, the PDCP layer may determine to disable the packet duplication for the one SLRB.

In yet another embodiment of the present application, the duplication determination rule may be at least based on a SL grant failure status, e.g., based on a SL grant failure number and a SL grant failure number threshold (which is also referred to as a SL grant failure status criterion). For example, the duplication determination rule may indicate: determining whether to enable or disable the packet duplication for a SLRB on a carrier at least based on whether a SL grant failure number on the carrier during a time period reaches a SL grant failure number threshold provided by an upper layer. In such an embodiment, the upper layer may be a layer higher than the MAC layer (e.g., a PDCP layer, a SDAP layer, a RRC layer, or a V2X layer).

In some embodiments of the present application, the SL grant failure number threshold and the time period is set per carrier, i.e., each carrier may have a corresponding SL grant failure number threshold and a time period. In some other embodiments of the present application, all the carriers may be set with the same SL grant failure number threshold and the same time period.

In some embodiments of the present application, the SL grant failure number threshold and the time period may be pre-configured in the UE, for example, in a SIM, in a USIM, or in a memory of the UE. In some other embodiments of the present application, the UE may receive the SL grant failure number threshold and the time period in at least one SIB broadcast by the BS. In some other embodiments of the present application, the UE may receive the SL grant failure number threshold and the time period in at least one RRC signaling transmitted by the BS. No matter how the SL grant failure number threshold and/or the time period is obtained by the UE, for the MAC layer of the UE, the PQI set is provided by the upper layer.

The SL grant failure on a carrier may be caused by various reasons, for example, re-evaluation (e.g., the UE performs sensing and re-evaluate that the SL grant is occupied by other UEs), pre-emption (e.g., the SL grant is pre-empted by another UE with a higher priority), and UL-SL prioritization (e.g., there is an uplink transmission with higher priority than the SL transmission needed to the transmitted). The MAC layer may count the SL grant failure number on a carrier during the time period and compare it with the SL grant failure number threshold. In the case that the SL grant failure number during the time period reaches the SL grant failure number threshold, the MAC layer of the UE may transmit an indication to the PDCP layer. The indication may indicate that the SL grant failure number on the carrier during the time period reaches the SL grant failure number threshold.

After receiving the indication, the PDCP layer may determine whether to enable or disable the packet duplication for at least one SLRB on the carrier of the one or more SLRBs to which the one or more QoS flows are mapped least based on the indication.

For example, in the case that the duplication determination rule indicates that the packet duplication for a SLRB is merely based on the SL grant failure status criterion, after receiving the indication, the PDCP layer may determine to enable packet duplication for each SLRB on the carrier.

In another example, the duplication determination rule indicates that the packet duplication for a SLRB is based on the SL grant failure status criterion together with one of the above three criteria (i.e., one of QoS parameter criterion, PQI criterion, and destination ID criterion). Then, after receiving the indication, for a SLRB on the carrier, the PDCP layer may determine to enable packet duplication based on the corresponding one of the above three criteria as stated above. In such an embodiment, one bit may be added in the configuration signaling to indicate that on the basis of one of the above three criteria, whether to enable or disable the SL grant failure status criterion.

In response to determining to enable the packet duplication for a SLRB, the PDCP layer may perform the packet duplication for the SLRB. In some embodiments of the present applications, performing packet duplication may include creating and delivering multiple copies of a PDCP packet (e.g., a PDCP PDU). In some embodiments of the present application, performing the packet duplication may include activating additional one or more legs from all configured legs by the network (e.g., the BS), such that the UE may transmit the multiple copies of the PDCP packet (e.g., a PDCP PDU) in the multiple legs, wherein each leg may be associated with a corresponding carrier. In an embodiment of the present application, which additional leg(s) to be activated may be up to UE implementation (i.e., determined based on UE itself). In another embodiment of the present application, the UE may be in mode 1 (e.g., the resource is configured by the BS) as specified in 3GPP standard documents, and which additional leg(s) may be indicated by the network, e.g., by a MAC control element (CE) from the BS.

According to some other embodiments of the present application, the SDAP layer of the UE may determine whether to perform a packet duplication based on a duplication determination rule. In such embodiments, the SDAP layer may determine whether to perform the packet duplication for a QoS flow.

In an embodiment of the present application, the duplication determination rule may be based on a QoS parameter and a QoS parameter threshold (which is also referred to as a QoS parameter criterion). The QoS parameter threshold may be obtained by the UE through the same manners as the above embodiments.

For example, the duplication determination rule may indicate: determining whether to enable or disable a packet duplication for a QoS flow based on whether a QoS parameter associated with the QoS flow is higher than or equal to a QoS parameter threshold provided by an upper layer. In such an embodiment, the upper layer may be a layer higher than the SDAP layer (e.g., a RRC layer, or a V2X layer). The QoS parameter may be one of: priority, PDB, PER, etc.

In such embodiments, the SDAP layer may determine whether to enable or disable the packet duplication for a QoS flow of the one or more QoS flows based on the duplication determination rule. In the case that the QoS parameter is higher than or equal to the QoS parameter threshold, the SDAP layer may determine to enable the packet duplication for the QoS flow. Otherwise, the SDAP layer may determine to disable the packet duplication for the QoS flow.

In another embodiment of the present application, the duplication determination rule may be based on a PQI and a PQI set (which is also referred to as a PQI criterion). The PQI set may be obtained by the UE through the same manners as the above embodiments.

For example, the duplication determination rule may indicate: determining whether to enable or disable the packet duplication for a QoS flow based on whether a PQI of the QoS flow is included in a PQI set provided by an upper layer. In such an embodiment, the upper layer may be a layer higher than the SDAP layer (e.g., a RRC layer, or a V2X layer).

In such embodiments, the SDAP layer may determine whether to enable or disable the packet duplication for a QoS flow of the one or more QoS flows based on the duplication determination rule. For example, the SDAP may determine whether a PQI of the QoS flow is included in the PQI set. In the case that the PQI is included in the PQI set, the SDAP layer may determine to enable the packet duplication for the QoS flow. Otherwise, the SDAP layer may determine to disable the packet duplication for the QoS flow.

In yet another embodiment of the present application, the duplication determination rule may be based on a destination ID and a destination ID set (which is also referred to as a destination ID criterion). The destination ID may be obtained by the UE through the same manners as the above embodiments.

For example, the duplication determination rule may indicate: determining whether to enable or disable the packet duplication for a QoS flow based on whether a destination ID of the QoS flow is included in a destination ID set provided by an upper layer. In such an embodiment, the upper layer may be a layer higher than the SDAP layer (e.g., a RRC layer, or a V2X layer).

In such embodiments, the SDAP layer may determine whether to enable or disable the packet duplication for a QoS flow of the one or more QoS flows based on the duplication determination rule. For example, the SDAP may determine whether the destination ID associated with the QoS flow is included in the destination ID set. In the case that the destination ID is included in the destination ID set, the SDAP layer may determine to enable the packet duplication for the QoS flow. Otherwise, the SDAP layer may determine to disable the packet duplication for the QoS flow.

In yet another embodiment of the present application, the duplication determination rule may be at least based on a SL grant failure status, e.g., based on a SL grant failure number and a SL grant failure number threshold (which is also referred to as a SL grant failure status criterion). For example, the duplication determination rule may indicate: determining whether to enable or disable the packet duplication for a QoS flow on a carrier at least based on whether a SL grant failure number on the carrier reaches a SL grant failure number threshold provided by an upper layer. In such an embodiment, the upper layer may be a layer higher than the MAC layer (e.g., a PDCP layer, a SDAP layer, a RRC layer, or a V2X layer).

In some embodiments of the present application, the SL grant failure number threshold and the time period is set per carrier, i.e., each carrier may have a corresponding SL grant failure number threshold and a time period. In some other embodiments of the present application, all the carriers may be set with the same SL grant failure number threshold and the same time period. The SL grant failure number threshold and the time period may be obtained by the UE through the same manners as the above embodiments.

In such an embodiment, the MAC layer may count the SL grant failure number on a carrier during the time period and compare it with the SL grant failure number threshold. In the case that the SL grant failure number during the time period reaches the SL grant failure number threshold, the MAC layer of the UE may transmit an indication to the SDAP layer, wherein the indication may indicate that the SL grant failure number during the time period on the carrier reaches the SL grant failure number threshold.

After receiving the indication, the SDAP layer may determine whether to enable or disable the packet duplication for at least one QoS flow on the carrier of the one or more QoS flows at least based on the indication.

For example, in the case that the duplication determination rule indicates that the packet duplication for a QoS flow is merely based on the SL grant failure status criterion, after receiving the indication, the SDAP layer may determine to enable packet duplication for each QoS flow on the carrier.

In another example, the duplication determination rule indicates that the packet duplication for a QoS flow is based on the SL grant failure status criterion together with one of the above three criteria (i.e., one of QoS parameter criterion, PQI criterion, and destination ID criterion). Then, after receiving the indication, for a QoS on the carrier, the SDAP layer may determine to enable packet duplication based on the corresponding one of the above three criteria as stated above. In such an embodiment, one bit may be added in the configuration signaling to indicate that on the basis of one of the above three criteria, whether to enable or disable the SL grant failure status criterion.

In response to determining to enable the packet duplication for a QoS flow, the SDAP layer may map the QoS flow to a first SLRB for which the packet duplication is enabled of the one or more SLRBs. In response to determining to disable the packet duplication for the QoS flow, the SDAP layer may map the QoS flow to a second SLRB for which the packet duplication is disabled of the one or more SLRBs.

In an embodiment of the present applications, the upper layer (e.g., the RRC layer) may configure the SDAP layer of the UE and the PDCP layer of the UE that the first SLRB is enabled packet duplication and the second SLRB is disabled packet duplication, such that the PDCP layer of the UE may perform the duplication for the first SLRB, and not perform the packet duplication for the second SLRB.

In another embodiment of the present application, in response to determining to enable the packet duplication for the QoS flow, the SDAP layer may indicate to the PDCP layer (i.e., transmit an indication to the SDAP layer) that the packet duplication is enabled for the first SLRB; and in response to determining to disable the packet duplication for the QoS flow, the SDAP layer may indicate to the PDCP layer that the the packet duplication is disabled for the second SLRB. After receiving the indication, the PDCP layer may perform packet duplication for the first SLRB, but not perform packet duplication for the second SLRB.

For example, it is assumed that: there are two QoS flows (QOS flow #1 and QoS flow #2), and QoS flow #1 is determined by the SDAP layer to enable packet duplication, and QoS flow #2 is determined by the SDAP layer to disable packet duplication. Then, the SDAP layer may map QoS flow #1 to SLRB #1 for which the packet duplication is enable, and map QoS flow #2 to SLRB #2 for which the packet duplication is disabled.

In response to determining to enable the packet duplication for a SLRB (e.g., the first SLRB), the PDCP layer may perform the packet duplication for the SLRB. In some embodiments of the present applications, performing packet duplication may include creating and delivering multiple copies of a PDCP packet. In some embodiments of the present application, performing the packet duplication may include activating additional one or more legs from all configured legs by the network (e.g., the BS), such that the UE may transmit the multiple copies of the PDCP packet in the multiple legs, wherein each leg may be associated with a corresponding carrier. In an embodiment of the present application, which additional leg(s) to be activated may be up to UE implementation (i.e., determined based on UE itself). In another embodiment of the present application, the UE may be in mode 1 (e.g., the resource is configured by the BS) as specified in 3GPP standard documents, and which additional leg(s) may be indicated by the network, e.g., by a MAC CE from the BS.

According to some other embodiments of the present application, the SDAP layer of the UE may determine whether to perform a packet duplication based on a duplication determination rule. In such embodiments, the SDAP layer may determine whether to perform the packet duplication for a packet (e.g., a SDAP protocol data unit (PDU)) from a QoS flow.

In an embodiment of the present application, the duplication determination rule may be based on a QoS parameter and a QoS parameter threshold (which is also referred to as a QoS parameter criterion). The QoS parameter threshold may be obtained by the UE through the same manners as the above embodiments.

For example, the duplication determination rule may indicate: determining whether to enable or disable a packet duplication for a packet from a QoS flow based on whether a QoS parameter associated with the QoS flow is higher than or equal to a QoS parameter threshold provided by an upper layer. In such an embodiment, the upper layer may be a layer higher than the SDAP layer (e.g., a RRC layer, or a V2X layer). The QoS parameter may be one of: priority, PDB, PER, etc.

In such embodiments, the SDAP layer may determine whether to enable or disable the packet duplication for a packet from a QoS flow of the one or more QoS flows based on the duplication determination rule. In the case that the QoS parameter is higher than or equal to the QoS parameter threshold, the SDAP layer may determine to enable the packet duplication for the packet from the QoS flow. Otherwise, the SDAP layer may determine to disable the packet duplication for the packet from the QoS flow.

In another embodiment of the present application, the duplication determination rule may be based on a PQI and a PQI set (which is also referred to as a PQI criterion). The PQI set may be obtained by the UE through the same manners as the above embodiments.

For example, the duplication determination rule may indicate: determining whether to enable or disable the packet duplication for a packet from a QoS flow based on whether a PQI of the QoS flow is included in a PQI set provided by an upper layer. In such an embodiment, the upper layer may be a layer higher than the SDAP layer (e.g., a RRC layer, or a V2X layer).

In such embodiments, the SDAP layer may determine whether to enable or disable the packet duplication for a packet from a QoS flow of the one or more QoS flows based on the duplication determination rule. For example, the SDAP may determine whether a PQI of the QoS flow is included in the PQI set, in the case that the PQI is included in the PQI set, the SDAP layer may determine to enable the packet duplication for the packet from the QoS flow. Otherwise, the SDAP layer may determine to disable the packet duplication for the packet from the QoS flow.

In yet another embodiment of the present application, the duplication determination rule may be based on a destination ID and a destination ID set (which is also referred to as a destination ID criterion). The destination ID set may be obtained by the UE through the same manners as the above embodiments.

For example, the duplication determination rule may indicate: determining whether to enable or disable the packet duplication for a packet from a QoS flow based on whether a destination ID of the QoS flow is included in a destination ID set provided by an upper layer. In such an embodiment, the upper layer may be a layer higher than the SDAP layer (e.g., a RRC layer, or a V2X layer).

In such embodiments, the SDAP layer may determine whether to enable or disable the packet duplication for a packet from a QoS flow of the one or more QoS flows based on the duplication determination rule. For example, the SDAP may determine whether the destination ID associated with the QoS flow is included in the destination ID set. In the case that the destination ID is included in the destination ID set, the SDAP layer may determine to enable the packet duplication for the packet from the QoS flow. Otherwise, the SDAP layer may determine to disable the packet duplication for the packet from the QoS flow.

In yet another embodiment of the present application, the duplication determination rule may be at least based on a SL grant failure status, e.g., based on a SL grant failure number and a SL grant failure number threshold (which is also referred to as a SL grant failure status criterion).

For example, the duplication determination rule may indicate: determining whether to enable or disable the packet duplication for a packet on a carrier at least based on whether a SL grant failure number on the carrier during a time period reaches a SL grant failure number threshold provided by an upper layer. In such an embodiment, the upper layer may be a layer higher than the MAC layer (e.g., a PDCP layer, a SDAP layer, a RRC layer, or a V2X layer).

In some embodiments of the present application, the SL grant failure number threshold and the time period is set per carrier, i.e., each carrier may have a corresponding SL grant failure number threshold and a time period. In some other embodiments of the present application, all the carriers may be set with the same SL grant failure number threshold and the same time period. The SL grant failure number threshold and the time period may be obtained by the UE through the same manners as the above embodiments.

In such an embodiment, the MAC layer may count the SL grant failure number on a carrier during the time period and compare it with the SL grant failure number threshold. In the case that the SL grant failure number during the time period reaches the SL grant failure number threshold, the MAC layer of the UE may transmit an indication to the SDAP layer, wherein the indication may indicate that the SL grant failure number on the carrier during the time period reaches the SL grant failure number threshold.

After receiving the indication, the SDAP layer may determine whether to enable or disable the packet duplication for a packet on the carrier from a QoS flow of the one or more QoS flows at least based on the indication.

For example, in the case that the duplication determination rule indicates that the packet duplication for a packet is merely based on the SL grant failure status criterion, after receiving the indication, the SDAP layer may determine to enable packet duplication for each packet on the carrier.

In another example, the duplication determination rule indicates that the packet duplication for a packet is based on the SL grant failure status criterion together with one of the above three criteria (i.e., one of QoS parameter criterion, PQI criterion, and destination ID criterion). Then, after receiving the indication, for a packet on the carrier, the SDAP layer may determine to enable packet duplication based on the corresponding one of the above three criteria as stated above. In such an embodiment, one bit may be added in the configuration signaling to indicate that on the basis of one of the above three criteria, whether to enable or disable the SL grant failure status criterion.

In response to determining to enable the packet duplication for a packet, the SDAP layer may indicate, to the PDCP layer of the UE, that the packet duplication is enabled for the packet. In response to determining to disable the packet duplication for the packet, the SDAP layer may indicate, to the PDCP layer of the UE, that the packet duplication is disabled for the packet.

In some embodiments of the present application, the above indicating may occur when the SDAP layer delivers the packet (e.g., a SDAP PDU) to the PDCP layer. For example, the SDAP layer may include an indication regarding whether to enable or disable packet duplication for the packet in the packet header of the packet. In some other embodiments of the present application, whether to enable or disable packet duplication for the packet may be indicated via an internal signaling from the SDAP layer to the PDCP layer.

After receiving the SDAP PDU and the indication (or the internal signaling), the PDCP layer may perform packet duplication for the PDCP PDU which includes the SDAP PDU that enabled packet duplication, and the PDCP layer may not perform packet duplication for the PDCP PDU which does not includes SDAP PDU that enabled packet duplication. In some embodiments of the present applications, performing packet duplication may include creating and delivering multiple copies of a PDCP packet (e.g., PDCP PDU). In some embodiments of the present application, performing the packet duplication may include activating additional one or more legs from all configured legs by the network (e.g., the BS), such that the UE may transmit the multiple copies of the PDCP packet in the multiple legs, wherein each leg may be associated with a corresponding carrier. In an embodiment of the present application, which additional leg(s) to be activated may be up to UE implementation (i.e., determined based on UE itself). In another embodiment of the present application, the UE may be in mode 1 (e.g., the resource is configured by the BS) as specified in 3GPP standard documents, and which additional leg(s) may be indicated by the network, e.g., by a MAC CE from the BS.

FIG. 4 illustrates a simplified block diagram of an exemplary apparatus 400 for packet duplication according to some embodiments of the present application. The apparatus 400 may include a SL apparatus, e.g., a UE, a PDCP entity of the UE, a SDAP entity of the UE.

Referring to FIG. 4, the apparatus 400 may include at least one processor 404 and at least one transceiver 402 coupled to the processor 404.

Although in this figure, elements such as the at least one transceiver 402 and processor 404 are described in the singular, the plural is contemplated unless a limitation to the singular is explicitly stated. In some embodiments of the present application, the transceiver 402 may be divided into two devices, such as a receiving circuitry and a transmitting circuitry. In some embodiments of the present application, the apparatus 400 may further include an input device, a memory, and/or other components.

According to some embodiments of the present application, the apparatus 400 may be a UE. The processor 404 may be configured to determine whether to enable or disable a packet duplication associated with one or more QoS flows mapped into SLRBs based on a duplication determination rule; and in response to determining to enable a packet duplication, perform the packet duplication.

In some embodiments of the present application, the apparatus 400 may further include at least one non-transitory computer-readable medium. In some embodiments of the present disclosure, the non-transitory computer-readable medium may have stored thereon computer-executable instructions to cause a processor to implement the method with respect to a UE as described above. For example, the computer-executable instructions, when executed, cause the processor 404 to interact with the transceiver (or transmitter and/or the receiver), so as to perform operations of the methods, e.g., as described in view of FIG. 3.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for packet duplication, including a processor and a memory. Computer programmable instructions for implementing a method for packet duplication are stored in the memory, and the processor is configured to perform the computer programmable instructions to implement the method for packet duplication. The method for packet duplication may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for packet duplication according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
determine whether to enable or disable a packet duplication associated with one or more quality of service (QOS) flows mapped into one or more sidelink radio bearers (SLRBs) based on a duplication determination rule; and
in response to determining to enable a packet duplication, perform the packet duplication.

2. The UE of claim 1, wherein whether to perform the packet duplication based on the duplication determination rule is determined in a packet data convergence protocol (PDCP) layer of the UE.

3. The UE of claim 2, wherein the duplication determination rule indicates: determining whether to enable or disable a packet duplication for a SLRB based on whether a QoS parameter for the SLRB is higher than or equal to a QoS parameter threshold provided by an upper layer, and wherein the at least one processor is further configured to cause the UE to:
receive one or more QoS parameters for the one or more QoS flows mapped into one SLRB, each QoS parameter associated with a QoS flow;
determine a QoS parameter for the one SLRB with a most stringent QoS requirement of the one or more QoS flows; and
determine whether to enable or disable the packet duplication for the one SLRB based on the duplication determination rule.

4. The UE of claim 2, wherein the duplication determination rule indicates: determining whether to enable or disable the packet duplication for a SLRB based on whether a PC5 QoS identifier (PQI) associated with the SLRB is included in a PQI set provided by an upper layer, and wherein the at least one processor is further configured to cause the UE to:
receive one or more PQIs for the one or more QoS flows mapped into one SLRB; and
determine whether to enable or disable the packet duplication for the one SLRB based on the duplication determination rule.

5. The UE of claim 2, wherein the duplication determination rule indicates: determining whether to enable or disable the packet duplication for a SLRB based on whether a destination identity (ID) associated with the SLRB is included in a destination ID set provided by an upper layer, and wherein the at least one processor is further configured to cause the UE to:
receive a destination ID for the one or more QoS flows mapped into one sidelink radio bearer (SLRB); and
determine whether to enable or disable the packet duplication for the one SLRB based on the duplication determination rule.

6. The UE of claim 2, wherein the duplication determination rule indicates: determining whether to enable or disable the packet duplication for a SLRB on a carrier at least based on whether a sidelink (SL) grant failure number on the carrier during a time period reaches a SL grant failure number threshold provided by an upper layer, and wherein the at least one processor is further configured to cause the UE to:
receive, from a medium access control (MAC) layer of the UE, an indication indicating that the SL grant failure number on the carrier during the time period reaches the SL grant failure number threshold; and
determine whether to enable or disable the packet duplication for at least one SLRB on the carrier of the one or more SLRBs at least based on the indication.

7. The UE of claim 1, wherein whether to perform a packet duplication based on a duplication determination rule is determined in a service data adaptation protocol (SDAP) layer of the UE.

8. The UE of claim 7, wherein the duplication determination rule indicates: determining whether to enable or disable a packet duplication for a QoS flow based on whether a QoS parameter associated with the QoS flow is higher than or equal to a QoS parameter threshold provided by an upper layer, and wherein the at least one processor is further configured to cause the UE to:
determine whether to enable or disable the packet duplication for a QoS flow of the one or more QoS based on the duplication determination rule;
in response to determining to enable the packet duplication:
map the QoS flow into a first SLRB for which the packet duplication is enabled of the one or more SLRBs; and
in response to determining to disable the packet duplication:
map the QoS flow into a second SLRB for which the packet duplication is disabled.

9. The UE of claim 7, wherein the duplication determination rule indicates: determining whether to enable or disable the packet duplication for a QoS flow based on whether a PC5 QoS identifier (PQI) of the QoS flow is included in a PQI set provided by an upper layer, and wherein the at least one processor is further configured to cause the UE to:
determine whether to enable or disable the packet duplication for a QoS flow of the one or more QoS flows based on the duplication determination rule;
in response to determining to enable the packet duplication:
map the QoS flow into a first SLRB for which the packet duplication is enabled of the one or more SLRBs;
in response to determining to disable the packet duplication:
map the QoS flow into a second SLRB for which the packet duplication is disabled of the one or more SLRBs.

10. The UE of claim 7, wherein the duplication determination rule indicates: determining whether to enable or disable the packet duplication for a QoS flow based on whether a destination identity (ID) of the QoS flow is included in a destination ID set provided by an upper layer, and wherein the at least one processor is further configured to cause the UE to:
determine whether to enable or disable the packet duplication for a QoS flow of the one or more QoS flows based on the duplication determination rule;
in response to determining to enable the packet duplication:
map the QoS flow into a first SLRB for which the packet duplication is enabled of the one or more SLRBs; and
in response to determining to disable the packet duplication:
map the QoS flow into a second SLRB for which the packet duplication is disabled of the one or more SLRBs.

11. The UE of claim 8, wherein the first SLRB for which the packet duplication is enabled or the second SLRB for which the packet duplication is disabled is configured by a radio resource control (RRC) layer.

12. The UE of claim 8, wherein the at least one processor is further configured to cause the UE to:
in response to determining to enable the packet duplication:
indicate, to a packet data convergence protocol (PDCP) layer of the UE, that the packet duplication is enabled for the first SLRB; and
in response to determining to disable the packet duplication:
indicate, to the PDCP layer of the UE, that the packet duplication is disabled for the second SLRB.

13. The UE of claim 7, wherein the duplication determination rule indicates: determining whether to enable or disable the packet duplication for a QoS flow on a carrier at least based on whether a sidelink (SL) grant failure number on the carrier during a time period reaches a SL grant failure number threshold provided by an upper layer, and wherein the at least one processor is further configured to cause the UE to:
receive, from a medium access control (MAC) layer of the UE, an indication indicating that the SL grant failure number on the carrier during the time period reaches the SL grant failure number threshold; and
determine whether to enable or disable the packet duplication for at least one Qos flow on the carrier of the one or more QoS flows at least based on the indication.

14. The UE of claim 7, wherein the duplication determination rule indicates: determining whether to enable or disable the packet duplication for a packet from a QoS flow based on whether a QoS parameter associated with the QoS flow is higher than or equal to a QoS parameter threshold provided by an upper layer, and wherein the at least one processor is further configured to cause the UE to:
determine whether to enable or disable the packet duplication for a packet from a QoS flow of the one or more QoS flows based on the duplication determination rule;
in response to determining to enable the packet duplication for the packet, indicate, to a packet data convergence protocol (PDCP) layer of the UE, that the packet duplication is enabled for the packet; and
in response to determining to disable the packet duplication for the packet, indicate, to the PDCP layer of the UE, that the packet duplication is disabled for the packet.

15. The UE of claim 1, wherein performing the packet duplication comprises activating additional one or more legs configured by a network.

16. A processor for wireless communication, comprising:
at least one controller coupled with at least one memory and configured to cause the processor to:
determine whether to enable or disable a packet duplication associated with one or more quality of service (QOS) flows mapped into one or more sidelink radio bearers (SLRBs) based on a duplication determination rule; and
in response to determining to enable a packet duplication, perform the packet duplication.

17. The processor of claim 16, wherein whether to perform the packet duplication based on the duplication determination rule is determined in a packet data convergence protocol (PDCP) layer of a user equipment (UE) that includes the processor.

18. The processor of claim 17, wherein the duplication determination rule indicates: determining whether to enable or disable a packet duplication for a SLRB based on whether a QoS parameter for the SLRB is higher than or equal to a QoS parameter threshold provided by an upper layer, and wherein the at least one controller is further configured to cause the processor to:
receive one or more QoS parameters for the one or more QoS flows mapped into one SLRB, each QoS parameter associated with a QoS flow;
determine a QoS parameter for the one SLRB with a most stringent QoS requirement of the one or more QoS flows; and
determine whether to enable or disable the packet duplication for the one SLRB based on the duplication determination rule.

19. The processor of claim 16, wherein whether to perform a packet duplication based on a duplication determination rule is determined in a service data adaptation protocol (SDAP) layer of a user equipment (UE) that includes the processor.

20. A method performed by a user equipment (UE), the method comprising:
determining whether to enable or disable a packet duplication associated with one or more quality of service (QOS) flows mapped into one or more sidelink radio bearers (SLRBs) based on a duplication determination rule; and
in response to determining to enable a packet duplication, performing the packet duplication.
